(19) United States
(12) Patent Application Publication
(10) Pub. No.: US 2023/0175638 A1
(43) Pub. Date: Jun. 8, 2023

(54) ANGLE ADJUSTABLE MICROSCOPE HOLDER

(71) Applicant: SHENZHEN MIKELONG TECHNOLOGY CO., LTD., SHENZHEN (CN)

(72) Inventors: GONGLE ZHAO, SHENZHEN (CN); SHANLIN WANG, SHENZHEN (CN); CHONG XIONG, SHENZHEN (CN)

(21) Appl. No.: 17/553,862

(22) Filed: Dec. 17, 2021

(30) Foreign Application Priority Data
Dec. 2, 2021 (CN) 202111473267.9

(51) Int. Cl. F16M 11/18; F16M 11/20; F16M 11/04; G02B 21/24

(52) U.S. Cl. CPC F16M 11/18; F16M 11/2021; F16M 11/046; G02B 21/24

(57) ABSTRACT

Provided is an angle adjustable microscope holder. The angle adjustable microscope holder comprises a base. The base is provided with a rotating piece, the rotating piece is detachably connected with a lifting rod, the lifting rod rotates along with the rotating piece, the lifting rod is provided with a spur rack, the lifting rod is connected with a moving piece in a sleeved manner, the moving piece is provided with a fixing ring, and the fixing ring is configured to fix a microscope. A part of the moving piece is meshed with the spur rack to drive the moving piece to slide relative to the lifting rod. A cross section of the lifting rod is a special-shaped cross section, and the moving piece fits a contact surface of the lifting rod in shape.

### BACKGROUND OF THE INVENTION

### 1. Technical Field

The present invention relates to the technical field of microscopes, in particular to an angle adjustable microscope holder.

### 2. Description of Related Art

Digital microscopes are part of optical, digital and video microscope industries, and are widely applied to aspects in production and living such as intelligent manufacturing, quality control, medical assistance, teaching research, archeological exploration, collection authentication and so on.

In a process of using the digital microscope, it is necessary to fix a conventional microscope by using an extra holder, so that it is convenient to observe objects at a fixed angle. For example, a document with an application number 202021183539.2 discloses a digital microscope rotating holder. Although it is longer in lifting stroke and wide in rotating range, the design on stability is not excellent enough, and meanwhile, fine design is not available on connection between rotating pieces, friction between the rotating pieces is much, and errors such as displacement are caused as the rotating pieces are worn after long-term use. It is found by the inventor in further use that as far as the lifting rod with a long stroke is concerned, as weights of components at two ends are distributed on a same side, if stability design is not available on the lifting rod, it is easy to cause swing in up-down adjustment, and when the lifting rod is rotated, a component for fixing the microscope will have a radial rotary displacement relative to the lifting rod, which affects the precision of the microscope. Meanwhile, interference and wear which may happen on the rotating rod and the lifting rod are not solved well. Therefore, on this basis, it is necessary to further solve the stability of the lifting rod and the wear problem of the rotating pieces.

### BRIEF SUMMARY OF THE INVENTION

In order to solve the problem of stability, rotary wear and placing stability of the lifting rod in the prior art when the holder is rotated at an existing angle.

The present invention provides an angle adjustable microscope holder, including a base, the base being provided with a rotating piece, the rotating piece being detachably connected with a lifting rod, the lifting rod rotating along with the rotating piece, the lifting rod being provided with a spur rack, the lifting rod being connected with a moving piece in a sleeved manner, the moving piece being provided with a fixing ring, and the fixing ring being configured to fix a microscope; a part of the moving piece being meshed with the spur rack to drive the moving piece to slide relative to the lifting rod, wherein a cross section of the lifting rod is a special shaped cross section, and the moving piece fits a contact surface of the lifting rod in shape.

Preferably, the moving piece includes a movable support, one end of the movable support being provided with the fixing ring and the other end thereof being provided with a special-shaped hole connected with the lifting rod in a sleeving manner, and the special-shaped hole fitting a surface of the lifting rod in shape, wherein the angle adjustable microscope holder is further provided with an adjusting rod penetrating through the movable support, the adjusting rod being provided with a coaxial gear in a sleeved manner, the coaxial gear being partially exposed in the special-shaped hole and the coaxial gear being meshed with the spur rack.

Preferably, the moving piece includes a rotary handle and a nut bearing, the rotary handle being fixedly connected with two ends of the adjusting rod, the adjusting rod penetrating through the nut bearing and the nut bearing being fixedly connected with the movable support to form a limiting structure.

Preferably, the movable support is further provided with a fixing bolt, the fixing bolt penetrating through the special-shaped hole, the fixing bolt being in threaded connection with the movable support and the fixing bolt abutting against the lifting rod.

Preferably, a side wall of the fixing ring is connected with a tightening bolt, the tightening bolt abutting against the microscope.

Preferably, the rotating piece includes a U-shaped seat and a hinged piece, the U-shaped seat being fixedly connected with the base and the hinged piece being clamped in a clamping space of the U-shaped seat; the rotating piece further includes a fixing bolt in threaded connection to the U-shaped seat, the hinged piece being provided with a through hole where the fixing bolt penetrates through to form an abutting structure of the hinged piece; and the hinged piece can rotate round the fixing bolt as a rotation axis, and the hinged piece is detachably connected with the lifting rod.

Preferably, an end portion of the hinged piece is bended toward a direction away from the U-shaped seat to form a horizontal seat, and the lifting rod is in threaded connection with the horizontal set, so that the lifting rod and the U-shaped seat are not in a same vertical plane.

Preferably, a fastening gasket is further arranged between the U-shaped seat and the hinged piece, and the fastening gasket is arranged on the fixing bolt in a sleeved manner.

Preferably, the base is further connected with a lamp via a flexible piece.

Preferably, a bottom plate is further internally provided with a control plate and a rechargeable battery connected electrically, the control plate being electrically connected with the lamp.

The present invention has the beneficial effects that the present invention provides an angle adjustable microscope holder. The angle adjustable microscope holder includes a base. The base is provided with a rotating piece, the rotating piece is detachably connected with a lifting rod, the lifting rod rotates along with the rotating piece, the lifting rod is provided with a spur rack, the lifting rod is connected with a moving piece in a sleeved manner, the moving piece is provided with a fixing ring, and the fixing ring is configured to fix a microscope. A part of the moving piece is meshed with the spur rack to drive the moving piece to slide relative to the lifting rod. A cross section of the lifting rod is a special-shaped cross section, and the moving piece fits a contact surface of the lifting rod in shape. Compared with the prior art, the moving piece can slide stably up and down, and meanwhile, the moving piece does not swing in a radial direction in a swinging process. Further, the rotating piece is provided with a fastening gasket to prevent wear. Meanwhile, a hinged seat is arranged of a bended structure, so that the lifting rod can be carried better and the range of a rotating angle is restrained.

### BRIEF DESCRIPTION OF THE SEVERAL VIEWS OF THE DRAWINGS

FIG. 1 is a structure diagram of the present invention.

FIG. 2 is an exploded view of the present invention.

FIG. 3 is a schematic diagram of the present invention at an inclinable angle.

FIG. 4 is a structure diagram of a movable support of the present invention.

FIG. 5 is a section view of a movable support of the present invention.

FIG. 6 is a structure diagram of a rotating piece of the present invention.

### SYMBOL DESCRIPTION OF COMPONENTS

1, base; 11, flexible piece; 12, lamp;

2, rotating piece; 21, U-shaped seat; 211, fastening gasket; 22, hinged piece; 221, horizontal seat; 23, fixing bolt;

3, lifting rod; 31, spur rack;

4, moving piece; 41, fixing ring; 411, tightening bolt; 42, movable support; 421, special-shaped hole; 422, fixing bolt; 43, adjusting rod; 431, coaxial gear; 44, rotary handle; 45, nut bearing.

### DETAILED DESCRIPTION OF THE INVENTION

In order to express the present invention clearer, further description of the present invention will be made below in combination with drawings.

In the description below, details of common embodiments are given for deeper understanding of the present invention. Apparently, the described embodiments are merely a part of embodiments of the present invention and are not all the embodiments. It is to be understood that the specific embodiments are merely used for explaining the prevent invention, instead of limiting the prevent invention.

It is to be understood that when used in the description, the terms “comprise” and/or “include” indicates existence of features, integrals, steps, operations, components or assemblies described and shall not be exclusive of existence or addition of one or more of features, integrals, steps, operations, components, assemblies or sets thereof.

As described in the background art, in a scheme in the prior art, although it is lifted by way of the lifting rod and is matched with the rotating pieces to connect to realize a function that the lifting rod can be connected along with the rotating pieces, it has two design flaws: first, the lifting rod is prone to radial slippage when it inclines or it is adjusted in height as the lifting rod is cylindrical and there are many regions of arc-shaped surfaces; and second, as the lifting rod and the rotating axis of the rotating piece are in a same vertical surface, when the lifting rod rotates, the ultimate inclination angle thereof will make the lifting rod contact with the base first to lead to damage, and meanwhile, whether the rotating pieces are locked or not cannot be distinguished by judging whether the rotating pieces swing or not, so that there are still many aspects to be improved.

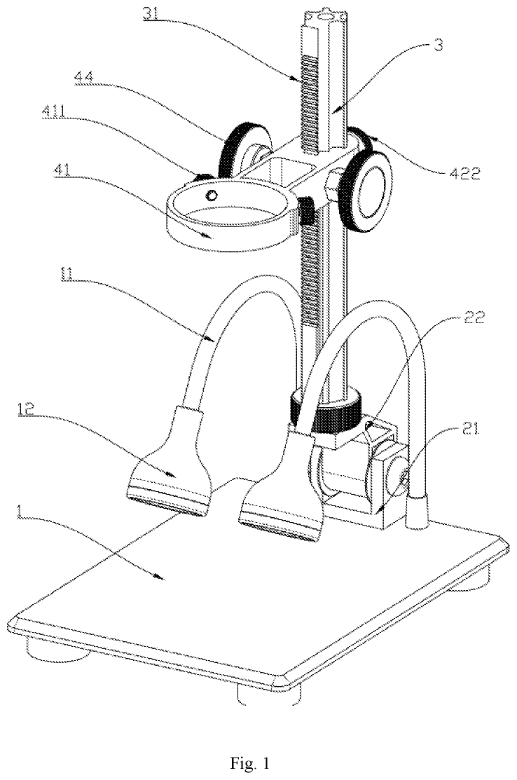

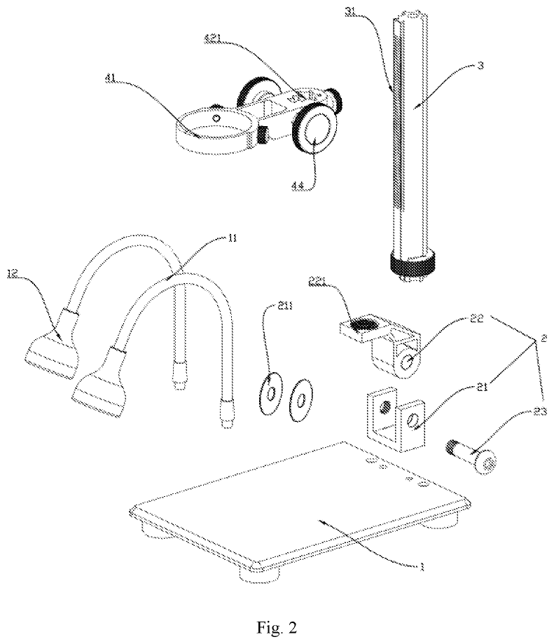

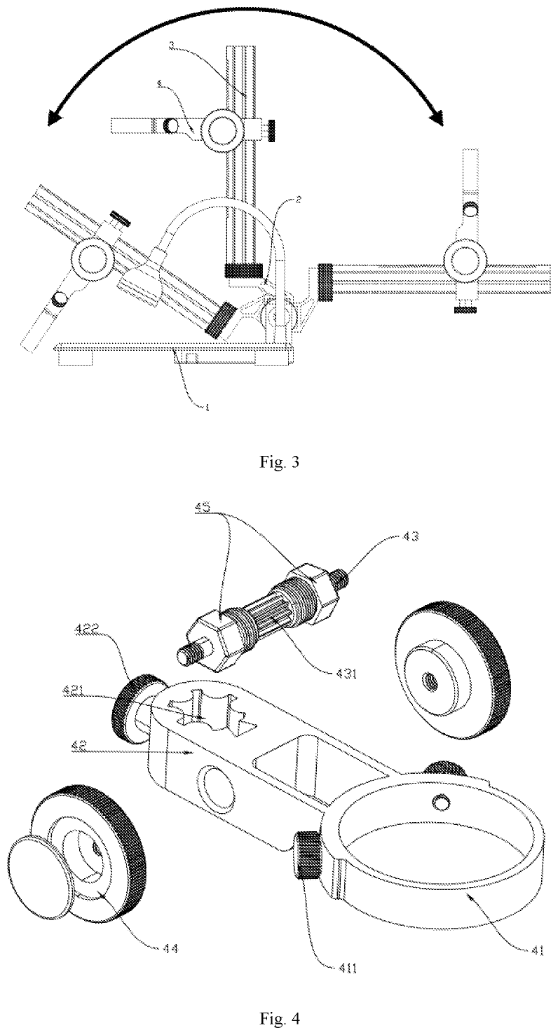

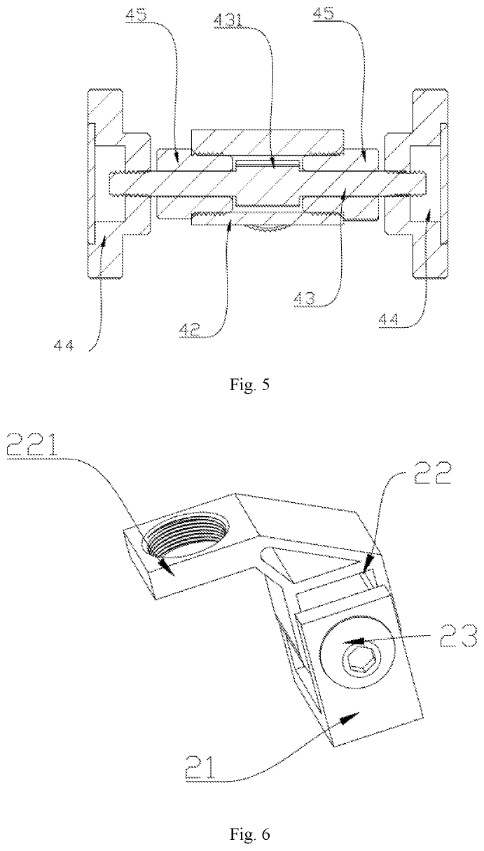

The present invention discloses an angle adjustable microscope holder. Referring to FIG. 1 to FIG. 6, it includes a base 1, the base 1 being provided with a rotating piece 2, the rotating piece 2 being detachably connected with a lifting rod 3, the lifting rod 3 rotating along with the rotating piece 2, the lifting rod 3 being provided with a spur rack 31, the lifting rod 3 being connected with a moving piece 4 in a sleeved manner, the moving piece 4 being provided with a fixing ring 41, and the fixing ring 41 being configured to fix a microscope; a part of the moving piece 4 being meshed with the spur rack to drive the moving piece to slide relative to the lifting rod, wherein a cross section of the lifting rod 3 is a special shaped cross section, and the moving piece fits a contact surface of the lifting rod in shape. As a special-shaped cross section is adopted, the area of the contact surface between the moving piece and the lifting rod will be increased greatly, so that a higher static pressure can be provided and the stability is kept. Meanwhile, the special-shaped section is different from an original cylindrical chambered surface and has few chambered surfaces, and concave-convex fluctuating trenches are arranged between adjacent chambered surfaces, a certain abutting force can be provided when the moving piece slides radially. Therefore, by arranging the special-shaped cross section, the moving piece can be prevented from sliding radially to the maximum extent.

In the embodiment, the moving piece 4 includes a movable support 42, one end of the movable support 42 being provided with the fixing ring 41 and the other end thereof being provided with a special-shaped hole 421 connected with the lifting rod in a sleeving manner, and the special-shaped hole 421 fitting a surface of the lifting rod in shape, wherein the angle adjustable microscope holder is further provided with an adjusting rod 43 penetrating through the movable support, the adjusting rod 43 being provided with a coaxial gear 431 in a sleeved manner, the coaxial gear 431 being partially exposed in the special-shaped hole and the coaxial gear being meshed with the spur rack. The adjusting rod can rotate when being impacted by an external force, and in the rotating process, its drives the coaxial gear to be meshed with the spur rack, so that it moves up and down along the spur rack. Furthermore, there is only the meshed portion of the coaxial gear exposed in the special-shaped hole, so that the assembling airtightness of the whole structure can be improved and it is guaranteed that displacement will not happen in repeated use.

In the embodiment, the moving piece 4 includes a rotary handle 44 and a nut bearing 45, the rotary handle 44 being fixedly connected with two ends of the adjusting rod, the adjusting rod 43 penetrating through the nut bearing 45 and the nut bearing 45 being fixedly connected with the movable support to form a limiting structure. The nut bearing can prevent the adjusting rod from being taken off in a twisting process, and meanwhile, the stability of the whole structure is improved.

In the embodiment, the movable support 42 is further provided with a fixing bolt 422, the fixing bolt 422 penetrates through the special-shaped hole, the fixing bolt is in threaded connection with the movable support, and the fixing bolt abuts against the lifting rod. By designing the special-shaped cross section, it is also necessary to fit the cross section in shape by using the fixing bolt, so that the abutting stability thereof can be improved.

In the embodiment, a side wall of the fixing ring 41 is connected with a tightening bolt 411, the tightening bolt abutting against the microscope.

In the embodiment, the rotating piece 2 includes a U-shaped seat 21 and a hinged piece 22, the U-shaped seat 21 being fixedly connected with the base 1 and the hinged piece 22 being clamped in a clamping space of the U-shaped seat 21; the rotating piece further includes a fixing bolt 23 in threaded connection to the U-shaped seat 21, the hinged piece 22 being provided with a through hole where the fixing bolt 23 penetrates through to form an abutting structure of the hinged piece; and the hinged piece 22 can rotate round the fixing bolt 23 as a rotation axis, and the hinged piece 22 is detachably connected with the lifting rod 3. Therefore, when the hinged piece is rotated, the hinged piece is extruded and abutted by the fixing screw and the U-shaped seat, so that the stability is guaranteed. Preferably, an end portion of the hinged piece 22 is bended toward a direction away from the U-shaped seat to form a horizontal seat 221, and the lifting rod 3 is in threaded connection with the horizontal seat 221, so that the lifting rod and the U-shaped seat are not in a same vertical plane. Therefore, in a static state, the lifting rod will have a certain rotating trend, and can be stably connected under extrusion of the U-shaped seat and the fixing screw, and therefore, it may be detected immediately in a non-stable state. Meanwhile, when it rotates, the horizontal seat generates a certain limiting action, thereby, it is ensured that the rotating range inclines at 50° towards one side of the base and inclines at 90° towards one side of the base based on the vertical lifting rod, and therefore, the using safety is guaranteed.

In the embodiment, a fastening gasket 211 is further arranged between the U-shaped seat 21 and the hinged piece 22, and the fastening gasket is arranged on the fixing bolt in a sleeved manner to prevent wear in the rotating process, and meanwhile, a pre-tightening force is improved.

In the embodiment, the base 1 is further connected with a lamp 12 via

a flexible piece 11.

In the embodiment, a bottom plate is further internally provided with a control plate and a rechargeable battery connected electrically, the control plate being electrically connected with the lamp.

The present invention has the technical effects that the fixing ring is configured to fix a microscope; a part of the moving piece is meshed with the spur rack to drive the moving piece to slide relative to the lifting rod. A cross section of the lifting rod is a special-shaped cross section, and the moving piece fits a contact surface of the lifting rod in shape. Compared with the prior art, the moving piece can slide stably up and down, and meanwhile, the moving piece does not swing in a radial direction in a swinging process. Further, the rotating piece is provided with a fastening gasket to prevent wear. Meanwhile, a hinged seat is arranged of a bended structure, so that the lifting rod can be carried better and the range of a rotating angle is restrained.

The above disclosed is merely several specific embodiments of the present invention, and the present invention is not limited thereto. Changes thought by any technical staff in the field shall fall into the protection scope of the present invention.

What is claimed is:

1. An angle adjustable microscope holder, characterized by comprising a base, the base being provided with a rotating piece, the rotating piece being detachably connected with a lifting rod, the lifting rod rotating along with the rotating piece, the lifting rod being provided with a spur rack, the lifting rod being connected with a moving piece in a sleeved manner, the moving piece being provided with a fixing ring, and the fixing ring being configured to fix a microscope; a part of the moving piece being meshed with the spur rack to drive the moving piece to slide relative to the lifting rod, wherein a cross section of the lifting rod is a special shaped cross section, and the moving piece fits a contact surface of the lifting rod in shape.

2. The angle adjustable microscope holder according to claim 1, characterized in that the moving piece comprises a movable support, one end of the movable support being provided with the fixing ring and the other end thereof being provided with a special-shaped hole connected with the lifting rod in a sleeving manner, and the special-shaped hole fitting a surface of the lifting rod in shape, wherein the angle adjustable microscope holder is further provided with an adjusting rod penetrating through the movable support, the adjusting rod being provided with a coaxial gear in a sleeved manner, the coaxial gear being partially exposed in the special-shaped hole and the coaxial gear being meshed with the spur rack.

3. The angle adjustable microscope holder according to claim 2, characterized in that the moving piece comprises a rotary handle and a nut bearing, the rotary handle being fixedly connected with two ends of the adjusting rod, the adjusting rod penetrating through the nut bearing and the nut bearing being fixedly connected with the movable support to form a limiting structure.

4. The angle adjustable microscope holder according to claim 2, characterized in that the movable support is further provided with a fixing bolt, the fixing bolt penetrating through the special-shaped hole, the fixing bolt being in threaded connection with the movable support and the fixing bolt abutting against the lifting rod.

5. The angle adjustable microscope holder according to claim 2, characterized in that a side wall of the fixing ring is connected with a tightening bolt, the tightening bolt abutting against the microscope.

6. The angle adjustable microscope holder according to claim 1, characterized in that the rotating piece comprises a U-shaped seat and a hinged piece, the U-shaped seat being fixedly connected with the base and the hinged piece being clamped in a clamping space of the U-shaped seat; the rotating piece further comprises a fixing bolt in threaded connection to the U-shaped seat, the hinged piece being provided with a through hole where the fixing bolt penetrates through to form an abutting structure of the hinged piece;
and the hinged piece can rotate round the fixing bolt as a rotation axis, and the hinged piece is detachably connected with the lifting rod.

7. The angle adjustable microscope holder according to claim 6, characterized in that an end portion of the hinged piece is bended toward a direction away from the U-shaped seat to form a horizontal seat, and the lifting rod is in threaded connection with the horizontal seat, so that the lifting rod and the U-shaped seat are not in a same vertical plane.

8. The angle adjustable microscope holder according to claim 6, characterized in that a fastening gasket is further arranged between the U-shaped seat and the hinged piece, and the fastening gasket is arranged on the fixing bolt in a sleeved manner.

9. The angle adjustable microscope holder according to claim 1, characterized in that the base is further connected with a lamp via a flexible piece.

10. The angle adjustable microscope holder according to claim 9, characterized in that a bottom plate is further internally provided with a control plate and a rechargeable battery connected electrically, the control plate being electrically connected with the lamp.
